(19) United States
(12) Patent Application Publication
(10) Pub. No.: US 2007/0168603 A1
(43) Pub. Date: Jul. 19, 2007

(54) Information recording apparatus and control method thereof

(75) Inventors: Yoriharu Takai, Kodaira-shi (JP); Kenji Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/585,138

(22) Filed: Oct. 24, 2006

(30) Foreign Application Priority Data
Jan. 17, 2006 (JP) 2006-009167

(51) Int. Cl. G06F 13/00

(52) U.S. Cl. 711/113

(57) ABSTRACT

According to one embodiment, there are provided an input unit which receives an input of command, a disk-shaped recording medium, a nonvolatile memory which serves as a cache memory for the disk-shaped recording medium, an acquisition unit which acquires status information denoting a status of the nonvolatile memory, and a control unit which judges a status of the nonvolatile memory on the basis of the status information acquired by the acquisition unit.

### CROSS-REFERENCE TO RELATED APPLICATIONS

This application is based upon and claims the benefit of priority from Japanese Patent Application No. 2006-009167, filed Jan. 17, 2006, the entire contents of which are incorporated herein by reference.

### BACKGROUND

1. Field

One embodiment of the invention relates to an information recording apparatus which carries out writing of information by using a nonvolatile semiconductor memory as a cache, on a high-capacity disk-shaped recording medium such as, for example, a hard disk or the like, and to a control method thereof.

2. Description of the Related Art

As is commonly known, in recent years, hard disks have become high-capacity and highly reliable information recording media, and have seen widespread use in many fields for recording of, for example, computer data, video data, audio data, and the like. Further, hard disks have been miniaturized so as to be able to be mounted in portable electronic devices.

Therefore, currently, in a miniaturization-oriented information recording apparatus using a hard disk, it is considered that, by using a nonvolatile memory which can achieve high-speed writing and high-speed reading of information as a cache memory for the hard disk, an attempt can be made to reduce battery consumption by improving writing and reading speeds of information, and by reducing the number of accesses of the hard disk, i.e., the number of writes and reads of information with respect to the hard disk.

Namely, this type of information recording apparatus makes a nonvolatile memory carry out writing and reading of information with respect to the outside, and makes a hard disk carry out information transfer with the nonvolatile memory, thereby speeding up operations for writing and reading information which are seen from the outside, and reducing the number of driving the hard disk. This type of information recording apparatus is called a nonvolatile (NV)-cache compliant hard disk drive (HDD), which has been standardized.

Here, in the information recording apparatus in which an attempt has been made to speed up operations for writing and reading information, and to reduce the number of accesses of the hard disk, it has been considered that a flash memory be used as a nonvolatile memory serving as a cache. By the way, a flash memory has a limitation in the number of rewritable times (for example, about a hundred thousand times), and has the characteristic in which, when the number of rewrites exceeds the limitation, errors are extremely easily generated, which lowers the reliability thereof.

Therefore, in an information recording apparatus in which recording of information is carried out onto a hard disk by using a nonvolatile memory as a cache, it has been strongly requested, not only to make an attempt to save electricity by reducing the number of accesses of the hard disk, but also to make improvement so as to efficiently control operations for writing and reading information in consideration of the fact that there is a limitation in the number of rewritable times of the nonvolatile memory, and the ease of use for users.

In Jpn. Pat. Appln. KOKAI Publication No. 2004-55102, there is disclosed a high-capacity storage medium in which both of a memory card and an HDD are mounted. The high-capacity storage medium can back up, for example, data of the memory card acquired from the outside, into the hard disk drive serving as a magnetic recording medium, and can transfer the data of the hard disk to the memory card to be mounted.

Further, in Japanese Patent No. 3407317, there is disclosed a storage device in portable form using a flash memory. In the Japanese Patent No. 3407317, in order to solve the problem that errors are easily generated when the number of rewrites (for example, a hundred thousand times) of a flash memory is increased, a method for managing data is provided in which, for example, the number of rewrites in only a specific area is prevented from increasing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows one embodiment of the present invention, and is a block diagram shown for explanation of an outline of an information recording apparatus;

FIG. 2 is a diagram shown for explanation of recording areas of a flash memory used for the information recording apparatus in the embodiment;

FIG. 3 is a diagram shown for explanation of counters of a flash memory interface used for the information recording apparatus in the embodiment;

FIG. 4 is a block diagram shown for explanation of one example of a controller used for the information recording apparatus in the embodiment;

FIG. 5 is a block diagram shown for explanation of one example of a host device connected to the information recording apparatus in the embodiment; and

FIG. 6 is a flowchart shown for explanation of one example of processing operations of the controller in the embodiment.

### DETAILED DESCRIPTION

Various embodiments according to the invention will be described hereinafter with reference to the accompanying drawings. In general, according to one embodiment of the invention, there are provided an input unit which receives an input of command, a disk-shaped recording medium, a nonvolatile memory which serves as a cache memory for the disk-shaped recording medium, an acquisition unit which acquires status information denoting a status of the nonvolatile memory, and a control unit which judges a status of the nonvolatile memory on the basis of the status information acquired by the acquisition unit.

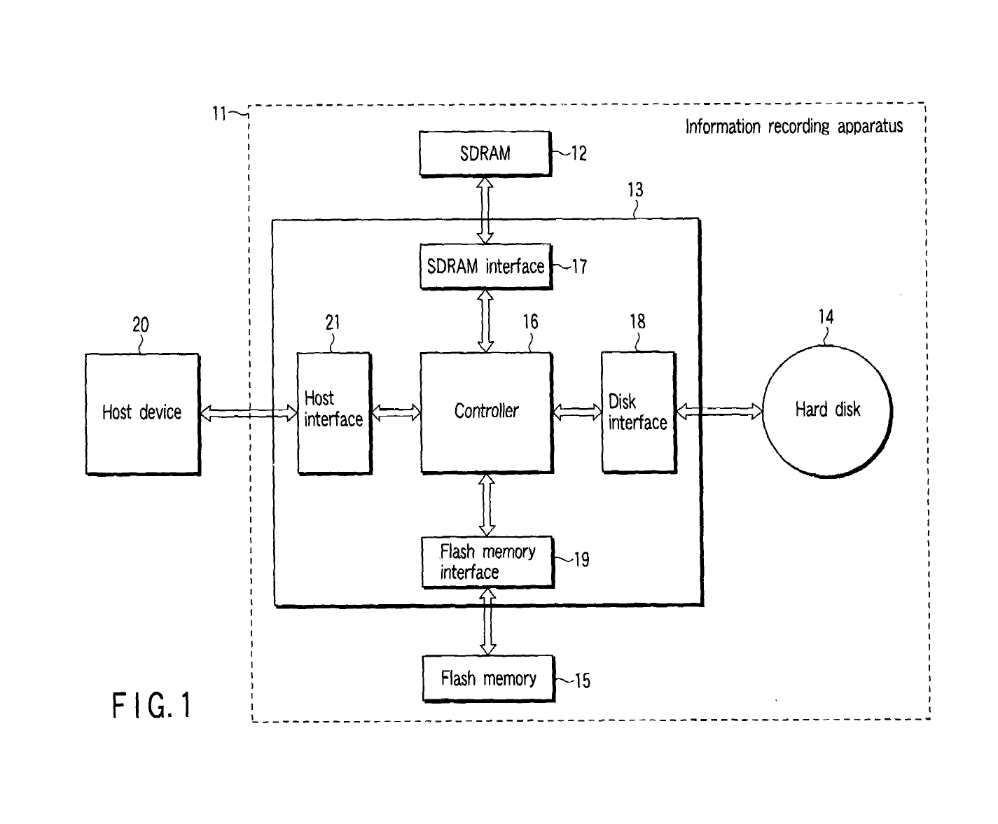

FIG. 1 shows an outline of an information recording apparatus 11 which will be described in the present embodiment. As the information recording apparatus 11 which will be described hereinafter, an NV-cache compliant HDD which is standardized in accordance with Non Volatile Cache Command Proposal for ATA8-ACS Revision 5 or the like is regarded as a target.

Namely, the information recording apparatus 11 has an SDRAM 12 functioning as a buffer, a one-chip LSI 13 having various circuit blocks built-in, a hard disk 14 serving as a high-capacity disk-shaped recording medium, a flash memory 15 serving as a nonvolatile memory functioning as a cache for the hard disk 14, or the like.

Among these, the LSI 13 has mounted thereon a controller 16 serving as a control unit for carrying out overall control of the information recording apparatus 11 when the information recording apparatus 11 executes various processing operations. Then, in the LSI 13, an SDRAM interface 17 which connects the controller 16 and the SDRAM 12 so as to be able to transfer information therebetween, a disk interface 18 which connects the controller 16 and the hard disk 14 so as to be able to transfer information therebetween, a flash memory interface 19 which connects the controller 16 and the flash memory 15 so as to be able to transfer information therebetween, a host interface 21 which connects the controller 16 and an external host device 20 so as to be able to transfer information therebetween, or the like are mounted.

Here, the above-described host device 20 is, for example, a personal computer (PC) or the like. For example, at the time of executing predetermined application software, the host device 20 executes writing and reading of information by utilizing the information recording apparatus 11, and can utilize the information recording apparatus 11 also as a destination to save information obtained finally.

In this case, the host device 20 issues a command to request writing of information or a command to request reading of information with respect to the information recording apparatus 11. These commands are supplied to the controller 16 via the host interface 21 to be analyzed.

In accordance therewith, the controller 16 controls the SDRAM 12, the flash memory 15, the hard disk 14, or the like to selectively execute writing of information supplied from the host device 20, reading of information to the host device 20, or the like. Further, the controller 16 has a function of enabling the SDRAM 12, the flash memory 15, and the hard disk 14 to mutually transfer information among them.

Basically, when a request to write information from the host device 20 is received, the controller 16 stores information to be written in the flash memory 15. Then, the controller 16 transfers the information stored in the flash memory 15 to the hard disk 14 to be stored at a predetermined timing, for example, when recording areas of the flash memory 15 are used to some extent or more.

Further, when a request to read information from the host device 20 is received, the controller 16 reads the required information from the hard disk 14 to be output to the host device 20. In this case, when there is the requested information on the flash memory 15, the information is read from the flash memory 15 and output to the host device 20.

Here, an error correcting code is added to the information (data) to be written into the flash memory 15. Then, error checking and correcting processing based on the error correcting code is applied to the data read from the flash memory 15.

Further, an error correcting code is added to the data to be recorded on the hard disk 14 as well. Then, error checking and correcting processing based on the error correcting code is applied to the data read from the hard disk 14.

In the present embodiment, a system is used in which the error correcting capability of error checking and correcting processing applied to data to be recorded on the hard disk 14 is extremely higher than that of the error checking and correcting processing applied to data to be recorded in the flash memory 15. Namely, the reliability of the data to be recorded on the hard disk 14 is dramatically higher than that of the data to be recorded in the flash memory 15.

Further, in the present embodiment, as one example, with respect to the flash memory 15, a unit of writing and reading information is regulated to 2 Kbytes. Moreover, with respect to the flash memory 15, a unit of erasing is regulated to 128 Kbytes. Further, with respect to the flash memory 15, as the number of writes and reads is increased, the element deteriorates, which increases the incidence of errors. Therefore, as information for assuring the performance of the element, the number of rewrites is regulated to about a hundred thousand times.

Here, among various commands which are set by the above-described regulations and can be executed by the information recording apparatus 11, commands necessary for explanation of the present embodiment will be described. First, a first command is to specify an LBA for writing information into the flash memory 15 among logical block addresses (LBAs) on the hard disk 14.

Further, a second command is, in the same way as the first command, to specify an LBA for writing information into the flash memory 15. However, in addition thereto, the second command is to request to read the information recorded in the LBA from the hard disk 14, and to write the read information into the flash memory 15.

The first and second commands described above correspond to PI=0 and PI=1 of Add LBA(s) to NV Cache Pinned Set in the regulations described above, and attribute information called pinned is added to an LBA instructed to store the information in the flash memory 15 by the host device 20.

A third command is to request to write information by specifying an LBA on the hard disk 14. When the third command is issued from the host device 20, the controller 16 examines whether or not pinned attribute information is made to correspond to the LBA requested to write. Then, when it is made to correspond thereto, writing is executed into an area corresponding to the LBA requested to write in the flash memory 15.

In contrast thereto, when pinned attribute information is not made to correspond to the LBA requested to write, the controller 16 determines whether to write the information into an area corresponding to the specified LBA in the flash memory 15, or to write the information into the specified LBA on the hard disk 14 at its own judgment, and executes it.

A fourth command is to request to read information by specifying an LBA on the hard disk 14. When the fourth command is issued from the host device 20, in a case in which an area corresponding to the specified LBA is already assigned in the flash memory 15, and it is judged that information newer than that on the hard disk 14 is stored in the area, the controller 16 needs to read the appropriate information from the flash memory 15.

In contrast thereto, when there is the same information on the hard disk 14 and in the flash memory 15, the controller 16 may read the appropriate information from the area corresponding to the LBA requested to read in the flash memory 15, and may read the information from the specified LBA on the hard disk 14.

Further, in a case in which, although the area corresponding to the specified LBA is already assigned in the flash memory 15, there is the latest data on the hard disk 14, the controller 16 needs to read the appropriate information from the specified LBA on the hard disk 14. Then, when the information is read from the hard disk 14, the controller 16 judges as well whether or not the information is cached in the flash memory 15.

Among LBAs to which pinned attribute information has not been made to correspond among the LBAs requested to write or read as the third and fourth commands described above, with respect to an LBA in which an area is assigned in the flash memory 15, and information is written into the assigned area in the flash memory 15, attribute information called unpinned is added.

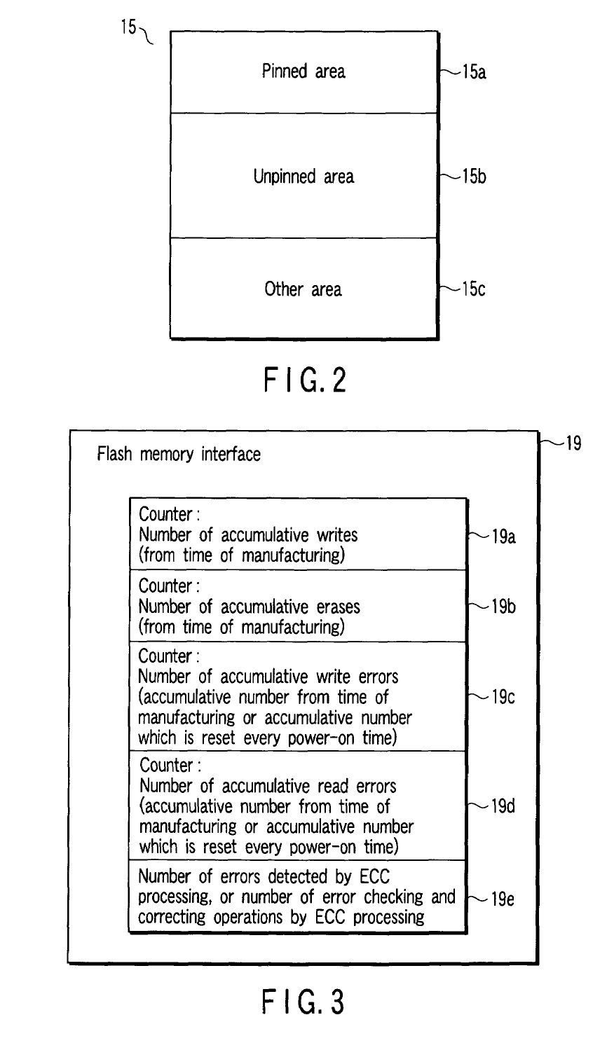

Then, an LBA to which pinned attribute information has been added is called a pinned LBA, and an area in the flash memory 15 corresponding to the pinned LBA is called a pinned area. Further, an LBA to which unpinned attribute information has been added is called an unpinned LBA, and an area in the flash memory 15 corresponding to the unpinned LBA is called an unpinned area. Therefore, in the flash memory 15, as shown in FIG. 2, a pinned area 15a, an unpinned area 15b, and an other area 15c are formed.

A fifth command is to request to prepare a space area of only a specified size in the flash memory 15. When the fifth command is issued from the host device 20, in a case in which a current space area in the flash memory 15 is smaller than a requested space area, the controller 16 ensures a space area of a specified size in the flash memory 15 by moving information of the specified size or more to the hard disk 14 from the unpinned area 15b in the flash memory 15. In this case, it is judged at the discretion of the controller 16 what information in which area in the unpinned area 15b in the flash memory 15 is moved to the hard disk 14, i.e., in which area a space area is formed, in the flash memory 15.

Next, the above-described flash memory interface 19 will be described. The flash memory interface 19 has a function of connecting the controller 16 and the flash memory 15 so as to be able to transfer information therebetween, and in addition, as shown in FIG. 3, various counters 19a to 19e are provided thereto. Respective counted values of these counters 19a to 19e are stored in, for example, an unillustrated nonvolatile memory provided in the flash memory interface 19. Note that it is possible to utilize the flash memory 15 in order to store the counted values.

First, the counter 19a is to accumulatively count the number of writes from the time of manufacturing. The counter 19b is to accumulatively count the number of erases from the time of manufacturing. The counter 19c is to accumulatively count the number of write errors from the time of manufacturing (or to be reset every power-on time). The counter 19d is to accumulatively count the number of read errors from the time of manufacturing (or to be reset every power-on time). The counter 19e is to accumulatively count the number of errors detected by error checking and correcting (ECC) processing, or the number of error corrections by ECC processing. Deteriorated status of the flash memory 15 can be judged on the basis of the counted values of these respective counters 19a to 19e.

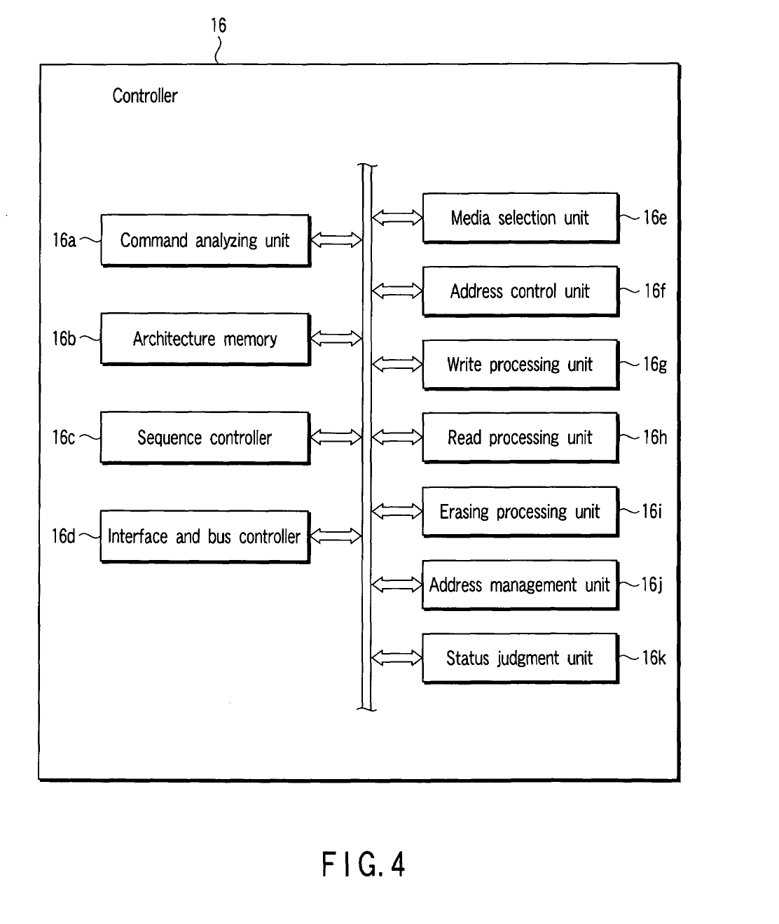

FIG. 4 shows one example of the above-described controller 16. The controller 16 has a command analyzing unit 16a which analyzes a command supplied from the host device 20 by applying decoding processing thereto. As a result of the analysis of the command analyzing unit 16a, software in an architecture memory 16b is specified, which sets an operational procedure into a sequence controller 16c.

The sequence controller 16c controls flow of information via an interface and a bus controller 16d. For example, when writing or reading of information is carried out, a media selection unit 16e specifies the flash memory 15 or the hard disk 14, and an address control unit 16f specifies a write address or a read address.

Then, during the writing of information, a write processing unit 16g executes transfer processing of information to be written. Further, during the reading of information, a read processing unit 16h executes transfer processing of information to be read.

Moreover, an erasing processing unit 16i is provided in the controller 16. The erasing processing unit 16i executes erasing processing of information recorded in the flash memory 15. Further, the erasing processing unit 16i can execute erasing processing of information recorded on the hard disk 14 as well.

Further, an address management unit 16j is provided in the controller 16. The address management unit 16j manages collectively addresses of recorded areas, unrecorded areas, and the like in the flash memory 15 and on the hard disk 14. Moreover, a status judgment unit 16k for monitoring access status of the hard disk 14 is provided in the controller 16.

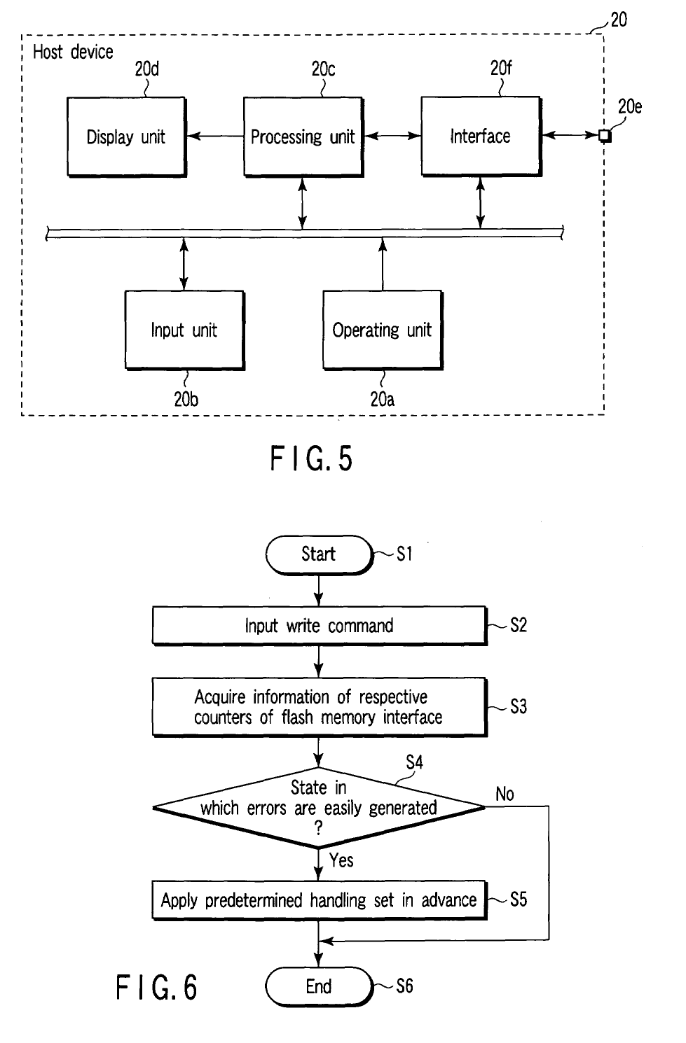

FIG. 5 shows one example of the above-described host device 20. The host device 20 has an operating unit 20a operated by a user, and an input unit 20b for carrying out acquisition of information from an external network or a predetermined information recording medium on the basis of an operation of the operating unit 20a.

Further, the host device 20 applies predetermined signal processing to information acquired by the input unit 20b, and has a processing unit 20c which generates a command for the information recording apparatus 11, and a display unit 20d for displaying a processing result of the processing unit 20c.

Moreover, the host device 20 has an interface 20f for outputting information serving as a processing result from the processing unit 20c or a command to the outside (the information recording apparatus 11) via a connection terminal 20e, and for supplying information input via the connection terminal 20e from the outside (the information recording apparatus 11), to the processing unit 20c.

Here, there is a limitation in the number of rewritable times (about a hundred thousand times) in the flash memory 15 as described above, and when accesses of writing, reading, erasing, or the like which are over the limited number of times are made, the incidence of write errors, or the probability of generating ECC errors at the time of reading written information is made higher. Further, when reading of information is repeatedly carried out with respect to the same recording area, the probability of generating ECC errors is made higher.

However, in the above-described regulations, because means by which the controller 16 acquires information denoting a status such as the number of rewrites, the number of erases, or the like with respect to the flash memory 15 is not defined, the controller 16 cannot judge whether or not the flash memory 15 is in a state in which errors are physically easily generated, resulting in obstacles at the time of carrying out writing, reading, erasing, or the like of information.

Then, in the present embodiment, the controller 16 is made to be able to acquire status information on the flash memory 15. In this case, the controller 16 acquires the information (which is recorded in, for example, the flash memory 15 as described above) of the respective counters 19a to 19e of the flash memory interface 19 as the status information of the flash memory 15 at predetermined timings at its own judgment.

FIG. 6 shows one example of processing operations by which the controller 16 acquires status information on the flash memory 15 at predetermined timings. Namely, the processing is started (block S1), and when a write command is supplied from the host device 20 in block S2, the controller 20 acquires the information (status information) of the respective counters 19a to 19e of the flash memory interface 19 in block S3.

Thereafter, the controller 20 judges whether or not the flash memory 15 is in a state in which errors are easily to be generated on the basis of the status information in block S4. In this case, it is judged whether or not the flash memory 15 is in a state in which errors are easily generated by, for example, comparing the information of the respective counters 19a to 19e of the flash memory interface 19 with reference values set in advance.

Then, when it is judged that the flash memory 15 is in a state in which errors are easily generated (YES), the processing unit 20c applies predetermined handling set in advance in block S5, and the processing is terminated (block S6). Further, when it is judged that the flash memory 15 is not in a state in which errors are easily generated (NO), the controller 16 terminates the processing directly (block S6).

Here, as the handling in block S5 described above, for example, there are techniques for reducing the number of accesses to the flash memory 15 in which the information in the flash memory 15 is transferred to the hard disk 14 to be evacuated, the information is recorded on the hard disk 14 when the third command described above is supplied from the host device 20, and the like.

In accordance with the embodiment described above, the controller 16 is made to be able to acquire status information on the flash memory 15 at predetermined timings such as at a timing of inputting a write command, and the like. Therefore, the controller 16 can judge whether or not the flash memory 15 is in a state in which errors are easily generated, on the basis of the acquired status information. Then, when it is judged that the flash memory 15 is in a state in which errors are easily generated, the controller 16 can apply processing set in advance. In accordance therewith, it is possible to beforehand reduce a scale of damage of information by errors in the flash memory 15, thereby making it possible not to enhance the reliability of the information to the utmost.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
an input unit configured to receive input of a command;
a disk-shaped recording medium;
a nonvolatile memory configured to serve as a cache memory for the disk-shaped recording medium;
an acquisition unit configured to acquire status information denoting a status of the nonvolatile memory; and
a control unit configured to carry out writing of information into the nonvolatile memory on the basis of a write command input to the input unit, recording of information recorded in the nonvolatile memory on the disk-shaped recording medium at a predetermined timing, and judging of a status of the nonvolatile memory on the basis of the status information acquired by the acquisition unit.

2. An information recording apparatus according to claim 1, wherein
the control unit is configured to carry out handling set in advance on the basis of a result in which a status of the nonvolatile memory is judged on the basis of the status information acquired by the acquisition unit.

3. An information recording apparatus according to claim 2, wherein
the control unit is configured to carry out handling by which the number of accesses to the nonvolatile memory is reduced when it is judged that the nonvolatile memory is in a state in which errors are easily generated.

4. An information recording apparatus according to claim 1, wherein
the control unit is configured to judge a status of the nonvolatile memory by comparing the status information acquired by the acquisition unit with reference values set in advance.

5. An information recording apparatus according to claim 1, wherein
the status information includes any of the number of writes, the number of erases, the number of write errors, and the number of read errors with respect to the nonvolatile memory.

6. An information recording apparatus according to claim 1, wherein
the status information includes the number of errors detected by error checking and correcting processing with respect to the information read from the nonvolatile memory.

7. An information recording apparatus according to claim 1, wherein
the status information includes the number of error checking and correcting with respect to the information read from the nonvolatile memory.

8. An information recording apparatus according to claim 1, wherein
the acquisition unit has counters configured to count any of the number of writes, the number of erases, the number of write errors, and the number of read errors with respect to the nonvolatile memory.

9. An information recording apparatus according to claim 1, wherein
the disk-shaped recording medium is a hard disk, and the nonvolatile memory is a flash memory.

10. A method for controlling an information recording apparatus comprising:
a first block of receiving an input of command;
a second block of writing information into a nonvolatile memory serving as a cache memory for a disk-shaped recording medium, on the basis of a write command input in the first block;
a third block of recording the information recorded in the nonvolatile memory in the second block on the disk-shaped recording medium at a predetermined timing;
a fourth block of acquiring status information denoting a status of the nonvolatile memory; and
a fifth block of judging a status of the nonvolatile memory on the basis of the status information acquired in the fourth block.

11. A method for controlling an information recording apparatus according to claim 10, further comprising
a sixth block of carrying out handling set in advance on the basis of the status of the nonvolatile memory judged in the fifth block.

12. A method for controlling an information recording apparatus according to claim 11, wherein
the sixth block carries out the handling so as to reduce the number of accesses to the nonvolatile memory when it is judged that the nonvolatile memory is in a state in which errors are easy to be generated in the fifth block.
